(19) United States
(12) Patent Application Publication
(10) Pub. No.: US 2009/0013262 A1
(43) Pub. Date: Jan. 8, 2009

(54) SYSTEMS AND METHODS FOR PROVIDING DOCUMENT COLLABORATION USING A FRONT AND BACK FRAMEWORK

(75) Inventors: Hideshi Hamaguchi, Beaverton, OR (US); Toru Takasuka, Portland, OR (US)

Correspondence Address: MADSON & AUSTIN, 15 WEST SOUTH TEMPLE, SUITE 900, SALT LAKE CITY, UT, 84101, US

(73) Assignee: LUNARR, Inc., Portland, OR (US)

(21) Appl. No.: 11/773,328

(22) Filed: Jul. 3, 2007

(51) Int. Cl. G06F 3/00

(52) U.S. Cl. 715/751

(57) ABSTRACT

A document server system is described that comprises a plurality of electronic documents, plurality of messages relating to the electronic documents and an interface server for providing a client user interface. The client user interface provides a front user interface configured to display an electronic document to collaborators of the document. The front user interface includes a front switching input. Activation of the front switching input causes the client user interface to switch from the front user interface to a back user interface. The client user interface provides the back user interface configured to display one or more of the plurality of messages for each individual user that is related to the document on the front user interface. The back user interface includes a back switching input. Activation of the back switching input causes the client user interface to switch from the back user interface to the front user interface.

### TECHNICAL FIELD

The present invention relates generally to computers and computer-related technology. More specifically, the present invention relates to systems and methods for providing document collaboration using a front and back framework.

### BACKGROUND

In today's society and workplace, there is frequently a need for users to collaborate in the production of their work. In the past, such collaboration was done using mechanisms such as meetings, the telephone and email. More recently, instant messaging applications have proved to be another useful means by which collaboration can take place. However, these mechanisms and practices still require coordination of various users' suggestions and integration of accepted suggestions into an original design, document, presentation, website, etc.

Often times, the document is shared with multiple users (e.g., via email) and these multiple users use a function such as “track changes” in Microsoft Word. Such collaborative working, however, involves each user loading the entire contents of the document on their machine and editing the document in a suitable editor that is required to be installed on the user's computer. For example, Word documents are edited using Microsoft Word.

In addition, contributing users that edit the document send the edits to the user that created the document. A consolidated markup document is created in which, paragraph by paragraph, the original paragraph is displayed along with the corresponding edited paragraph from each contributing user. The originating user then selects which of the edits will be included in the final document. However, the final document cannot be viewed until after the originating user has made all of his/her selections. Thus, the originating user cannot see the final document as it evolves from the original, i.e., as changes are made.

Further, the originating user is required to transfer documents to and from the collaborators (e.g., over the Internet). Unfortunately, security, control and ease-of-use problems exist. For example, in order to seek revisions to a document, an originating user removes a document from a document management system, and sends it to the collaborators, either by email or by posting it on a web portal. Removing the document from the secure and controlled environment of a document management system for editing might cause security and control problems. This process prohibits the originating user from easily tracking the document and its various revisions. Thus, benefits may be realized from improved systems and methods for providing efficient document review. In particular, benefits may be realized by providing systems and methods for providing document collaboration using a front and back framework.

### BRIEF DESCRIPTION OF THE DRAWINGS

Exemplary embodiments of the invention will become more fully apparent from the following description and appended claims, taken in conjunction with the accompanying drawings. Understanding that these drawings depict only exemplary embodiments and are, therefore, not to be considered limiting of the invention's scope, the exemplary embodiments of the invention will be described with additional specificity and detail through use of the accompanying drawings in which:

FIG. 1 is an embodiment of a user interface that may be used during collaborative review of a document;

FIG. 2 is a block diagram illustrating one embodiment of a system that facilitates collaborative review of a document;

FIG. 3 is a block diagram illustrating one embodiment of a system for enabling multiple users to review a document;

FIG. 4 is a flow diagram illustrating one embodiment of a method of providing a front side interface or a back side interface associated with a document to a user;

FIG. 5 is a block diagram illustrating one embodiment of multiple interfaces that may be accessed by a user;

FIG. 6 is an embodiment of a home interface;

FIG. 7 is an embodiment of a front side interface;

FIG. 8 is an embodiment of a back side interface;

FIG. 9 is a block diagram illustrating one embodiment of a document manager; and

FIG. 10 is a block diagram illustrating the major hardware components typically utilized in a computing device.

### DETAILED DESCRIPTION

A document server system is described. The system includes a computing device. The computing device includes a plurality of electronic documents, a plurality of messages relating to the electronic documents and an interface server for providing a client user interface to be displayed on a client display. The client user interface provides a front user interface configured to display one of the plurality of electronic documents. The front user interface includes a front switching input. Activation of the front switching input causes the client user interface to switch from the front user interface to a back user interface. The client user interface provides the back user interface configured to display one or more of the plurality of messages. The back user interface includes a back switching input, wherein activation of the back switching input causes the client user interface to switch from the back user interface to the front user interface.

In one embodiment, the front user interface includes a public area that is accessible by one or more authorized users. The back user interface includes a private area that is accessible by an authorized user. The computing device may be configured to automatically grant a user access to an electronic document upon receipt of a message relating to the electronic document.

In one embodiment, the computing device is configured to attach an electronic document different from one of the plurality of electronic documents to a message. The computing device may be configured to link the electronic document to one of the plurality of electronic documents.

The front switching input and the back switching input may be configured to execute a plurality of functions. Each of the plurality of electronic documents may include an identifier that links each of the plurality of electronic documents to a corresponding physical document. The front user interface further includes a toolbar for editing each of the plurality of electronic documents.

A method for providing multiple user interfaces relating to an electronic document is also described. A plurality of electronic documents is provided. A plurality of messages relating to the electronic documents is provided. A client user interface to be displayed on a client display is provided. The client user interface provides a front user interface configured to display one of the plurality of electronic documents, wherein the front user interface includes a front switching input, wherein activation of the front switching input causes the client user interface to switch from the front user interface to a back user interface. The client user interface provides the back user interface configured to display one or more of the plurality of messages, wherein the back user interface includes a back switching input, wherein activation of the back switching input causes the client user interface to switch from the back user interface to the front user interface.

A computer-readable medium comprising executable instructions is also described. A plurality of electronic documents is provided. A plurality of messages relating to the electronic documents is provided. A client user interface to be displayed on a client display is provided. The client user interface provides a front user interface configured to display one of the plurality of electronic documents, wherein the front user interface includes a front switching input, wherein activation of the front switching input causes the client user interface to switch from the front user interface to a back user interface. The client user interface provides the back user interface configured to display one or more of the plurality of messages, wherein the back user interface includes a back switching input, wherein activation of the back switching input causes the client user interface to switch from the back user interface to the front user interface.

Various embodiments of the invention are now described with reference to the Figures, where like reference numbers indicate identical or functionally similar elements. The embodiments of the present invention, as generally described and illustrated in the Figures herein, could be arranged and designed in a wide variety of different configurations. Thus, the following more detailed description of several exemplary embodiments of the present invention, as represented in the Figures, is not intended to limit the scope of the invention, as claimed, but is merely representative of the embodiments of the invention.

The word “exemplary” is used exclusively herein to mean “serving as an example, instance, or illustration.” Any embodiment described herein as “exemplary” is not necessarily to be construed as preferred or advantageous over other embodiments.

Many features of the embodiments disclosed herein may be implemented as computer software, electronic hardware, or combinations of both. To clearly illustrate this interchangeability of hardware and software, various components will be described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Where the described functionality is implemented as computer software, such software may include any type of computer instruction or computer executable code located within a memory device and/or transmitted as electronic signals over a system bus or network. Software that implements the functionality associated with components described herein may comprise a single instruction, or many instructions, and may be distributed over several different code segments, among different programs, and across several memory devices.

As used herein, the terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not necessarily all) embodiments of the disclosed invention(s)”, unless expressly specified otherwise.

The term “determining” (and grammatical variants thereof) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

Collaborative review of an electronic document generally suffers from several problems. Some examples of these problems may include redundant reviewing, feedback tracking, error logging, missing context, feedback conflicts and approval collection.

Redundant reviewing may occur when a document is reviewed by multiple reviewers and each reviewer inspects the same section of the document. Each of the reviewers may discover the same errors or issues within the document without knowledge of the other reviewers. Redundant reviewing can involve a substantial waste of time affecting the multiple reviewers and the owner(s) of the document.

A reviewer may also have difficulty in tracking the feedback provided by other reviewers regarding a document. For example, a reviewer may not be aware when feedback is incorporated into subsequent versions of the document. In addition, feedback conflicts may occur between different reviewers because one reviewer may not have access to the most current version of the document. The owner(s) of the document may also face the difficulty of maintaining an organized history of which reviewer provided certain feedback.

Furthermore, approval collection may be difficult with a plurality of reviewers. For example, it is often difficult for the document owner(s) to secure meaningful approvals from each of their reviewers. Reviewers may be negligent in returning an approval or disapproval, or even give an approval without having performed an adequate review. As previously mentioned, with a plurality of reviewers, it can be difficult to centrally track approvals and review comments. A reviewer may be more inclined to perform a quality review and give a more honest approval if their comments and sign-off approval are easily viewable by the other reviewers and the document owner(s).

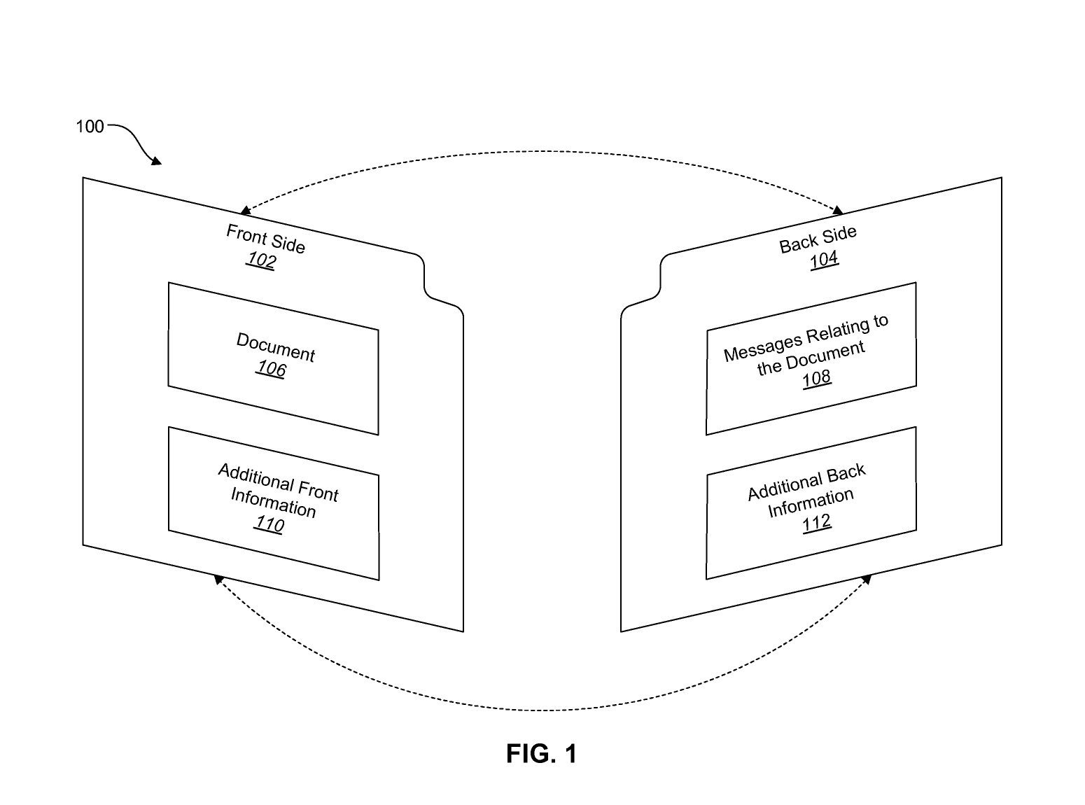

FIG. 1 is one embodiment of a user interface 100 that may be used during collaborative review of a document 106. The interface 100 may include a front side 102 and a back side 104. A user may alternate between the front side 102 and the back side 104. In the embodiment of FIG. 1, a user may either view the front side 102 or the back side 104. Through some user input, the interface 100 would flip from the front side 102 to the back side 104, and visa versa. It is to be understood that flipping between the front side 102 and the back side 104 indicates a conceptual flip and not a physical flip. For illustrative purposes, FIG. 1 shows both the front side 102 and the back side 104. In operation, the embodiment would typically only display either the front side 102 or the back side 104. The front side 102 and the back side 104 may each include information that may be displayed to the user. The information displayed on the front side 102 may be different than the information displayed on the back side 104. In one embodiment, the information associated with the front side 102 may be linked (or connected) to the information associated with the back side 104.

The front side 102 may include the document 106. In one embodiment, the document 106 includes an electronic document. The document may be a Hyper-Text Markup Language (HTML) document that is created by an editing tool included in the front side 102. The document 106 may also be a webpage, graphic, picture, music, etc. In one embodiment, the webpage may include a web application. For example, web applications that include documents, spread sheets, etc. may be shown in the front side 102 as the document 106. In addition, the document 106 may be a link for downloading a file that is to be reviewed. The link may be for any type of document, such as, but not limited to, Microsoft Word, Microsoft Excel, Microsoft Power Point, etc. based document, Photoshop based document, illustrator file, etc. In one embodiment, a document that is Microsoft based or any other type of document may be converted into an HTML format so that a user may view and edit the document in the front side 102. The document 106 may be any type of digital or electronic information that is displayed on the front side 102. In one embodiment, a user may upload and convert a document to the hyper text markup language (HTML) format. A wordprocessor/editing function may be implemented to edit the document in the HTML format.

A user may access the user interface 100 and view the front side 102. The document 106 may be displayed to the user. The user may view or edit the document 106. For example, if the document 106 included a document that had been converted from a Microsoft Word based document with text to a HTML based document, the user may delete or add text to the document 106. If the document 106 included a picture, the user may edit the colors of the picture, change the size of the picture, etc. The front side 102 may also include additional front information 110 that may be displayed to the user. The additional front information 110 may include tools to assist the user in editing the document 106. The additional front information 110 may also include various commands the user may select to be executed on the document 106. For example, the various commands may include a command to save, print, copy, export, version up, view only setting, etc. the document 106. Further, the additional front information 110 may include an identifier that identifies the document 106 to the user.

The back side 104 may include messages 108 relating to the document 106. The messages 108 may be related to edits executed on the document 106 displayed on the front side 102. A user may receive a message 108 from another user that has edited or viewed the document 106. The messages 108 may be organized in an electronic mailbox associated with a user. The mailbox may include messages that are organized according to the particular user and document the message is related to. The back side 104 may also include additional back information 112. The additional back information 112 may include various commands that may be executed on the messages 108. Examples of the various commands may include a command to reply to a message, forward a message, delete a message, etc. The additional back information 112 may also include an indication when new messages 108 are received, information relating to each user that accesses the document 106, information about a revision log and versions of the document 106 as well as information about other documents and links that relate to the document 106. In one embodiment, the back side 104 includes meta information such as collaborators, linked documents, revision log, additions to the messages, etc.

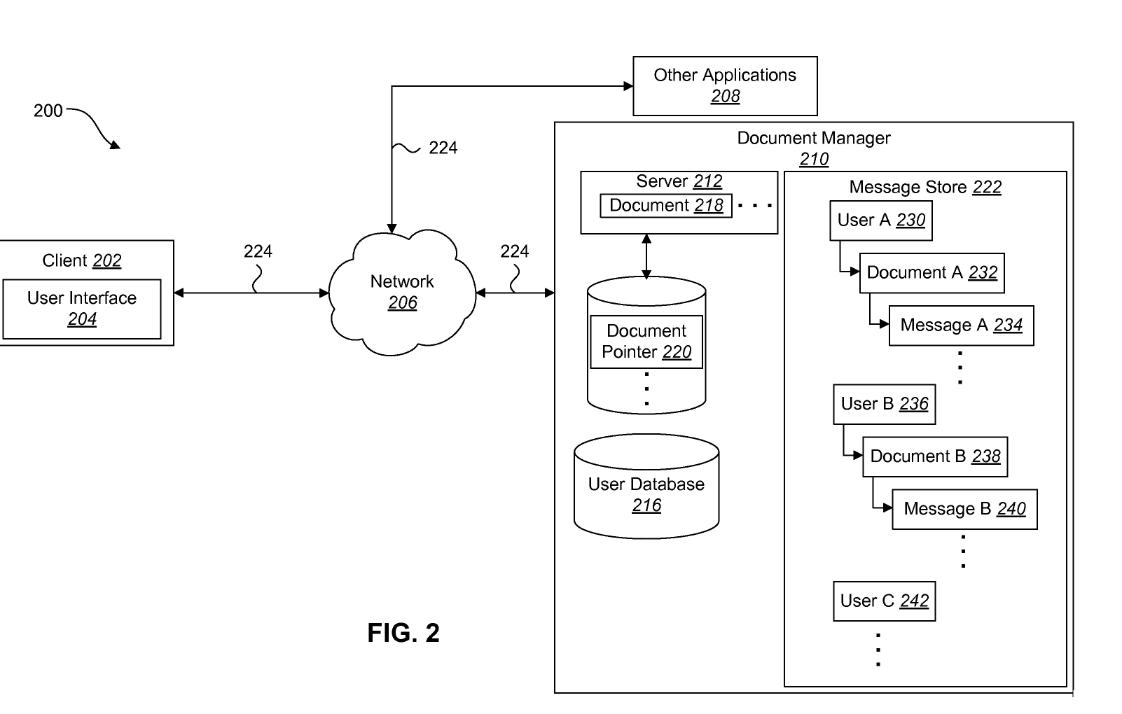

FIG. 2 is a block diagram illustrating one embodiment of a system 200 that facilitates collaborative review of a document 218. The system 200 includes a document manager 210 that includes a server 212, a user database 216, a document pointer 220 and a message store 222. In one embodiment, the document pointer 220 is also a database. The server 212 may include one or more documents 218. The document pointer 220 may be a record of each document 218 stored within the server 218. The document pointer 220 may include information relating to the document 218 that is “public.” For example, public information may be information that is available to other collaborators of the document 218.

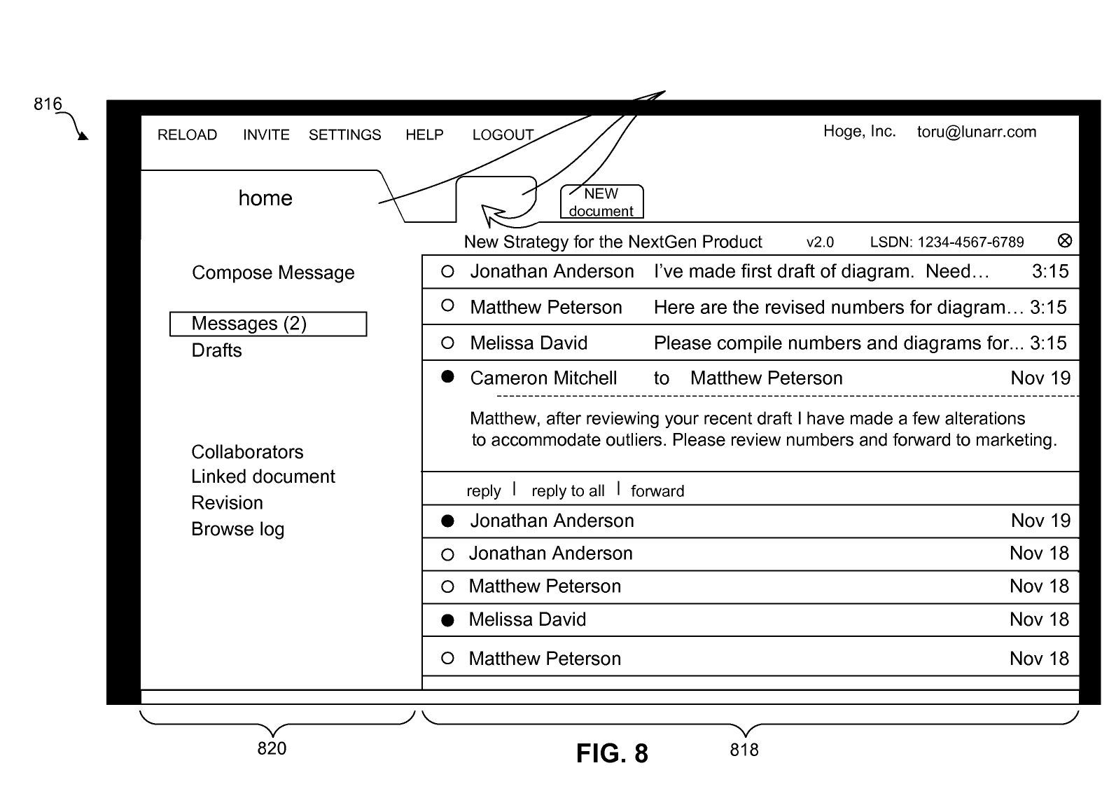

The message store 222 may store messages associated with a document and/or a user. The messages may be “private” such that only a particular user associated with the message may view and the message. For example, user A 230 may be reviewing document A 232. Message A 234 may be stored in the message store 222 in a file system relating to user A 230 and document A 232. Similarly, user B 236 may be reviewing document B 238. Message B 240 may be stored in a file system related to user B 236 and document B 238. The message store 222 may also store messages relating to additional users and documents, such as user C 242. In a further embodiment, user A 230 may send a message to user B 236 relating to document A 232. Sent message information may be stored in the message store 222 in a file system associated with user A 230. The message may also be stored in the message store 222 in a file system associated with user B 236. In other words, both user A 230 and user B 236 have message information stored in their respective file systems that relates to document A 232. In addition, an attachment function on the back side 104 allows a user to attach a document (such as the document 106) when sending a message to another user. The attached document is shown in as a linked document (further explained in FIG. 8).

The document manager 210 may be a platform for storing and managing the one or more documents 218 stored in the server 212. For example, the document manager 210 may enable a client 202 to view the document 218 via a user interface 204. As previously explained, the user interface 204 may allow the user to view a front side 102 and a back side 104. In one embodiment, the user interface 204 may be a web browser. The front side 102 includes the document 218 and the back side includes the messages relating to the user and the document 218. In other words, the front side is a public side in that the document 218 may be viewed, edited, etc. by collaborators of the document 218. The back side is a private side in that the messages on the back side may only be viewed by a particular user associated with the messages. For example, each user that edits and reviews a document is able to view a back side of a document that includes messages specifically for that particular user. A user may not view the back side of a document relating to another user. The client 202 may include any computing device, including, but not limited to, a personal computer (PC), a laptop, a personal digital assistant (PDA), a cellular telephone, etc.

A network 206 may enable a communications link 224 between the client 202 and the document manager 210. Other applications 208 may also establish a communications link 224 with the document manager 210 and the client 202. The other applications 208 may provide certain functions that a user operating the client 202 may execute on the document 218. For example, the other applications 208 may be developed by third party software providers and may provide editing functions that a user may incorporate when viewing and editing the document 218.

The document manager 210 also includes a user database 216. The user database 216 may include information about each user that is able to access the information managed by the document manager 210. For example, users included in the user database 216 are enabled to establish a communications link 224 between the client 202 and the document manager 210.

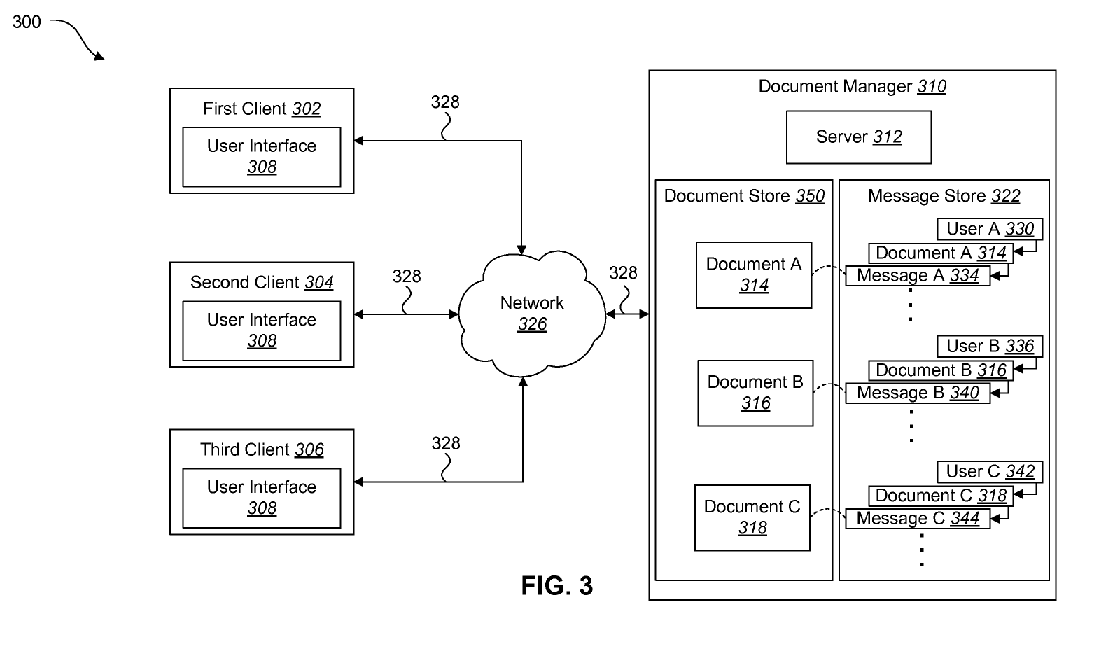

FIG. 3 is a block diagram illustrating one embodiment of a system 300 for enabling multiple users to review a document. The system 300 may include one or more clients. For example, the system 300 includes a first client 302, a second client 304 and a third client 306. While only three clients 302, 304 and 306 are illustrated, the present systems and methods may include any number of clients. The first 302, second 304 and third client 306 may each include a user interface 308 and each of the clients may establish a communications link 328 with a document manager 310 over a network 326. The document manager 310 includes a server 312, a document store 350 and a message store 322. The document store 350 includes a plurality of documents 314, 316, 318 and the message store 322 includes a plurality of messages 334, 340, 344. Document A 314, document B 316 and document C 318 may include information that is public. Public information may be information that is available to the user that uploaded the document. Public information may also be information that is open to collaborators (users that are reviewing and editing the document). In addition, public information may be information that is available to a particular group (i.e., a company) but not necessarily the general public. In other words, public information, as used in the present systems and methods, does not include information that is available to the general public. In one embodiment, the information included in each of the documents is open to each user belonging to a collaboration team. In other words, a user that is not part of the collaboration team is not allowed to view the information included in one or all of the documents managed by the document manager 310.

Document A 314 may be associated with message A 334. Message A 334 may be linked to user A 330 and stored in a file system corresponding to user A 330. Document B 316 may also be associated with message B 340. Message B 340 may be linked to user B 336 and stored in a file system corresponding to user B 336. Further, document C 318 may be associated with message C 344. Similarly, message C 344 may be linked to user C 342 and stored in a file system corresponding to user C 342. The information included in the messages may be private. In other words, messages may only be viewed by the user to whom the messages are addressed. The following example illustrates multiple users reviewing and editing a document.

A first user may establish a communications link 328 with the document manager 310 through the first client 302. In order to establish the communications link 328, the first user may access the user interface 308. The first user may be required to provide certain information in order to establish a communications link 328. For example, the first user may provide a username and password which may be compared to a usemame and password stored within the user database 216. The username and password may be associated with a subscription. For example, some embodiments may be subscription based requiring users to pay a subscription fee in order to use the document manager 310. If the information provided by the first user matches the information stored in the user database 216, the communications link 328 may be established. A second user and a third user may establish a communications link 328 with the document manager 310 through the second client 304 and the third client 306, respectively, in a similar manner.

The first user may create document A 314 and/or upload the document or create a link to the document manager 310 via the user interface 308. In other words, the first user creates an HTML document by using the editing tool. In a further embodiment, the first user creates a link to a website or creates a document on a web application. Users may edit the document on a web application on the front side 102 and also flip to the back side 104 to communication with the system 200. The document manager 310 may process document A 314 and the first user may choose to view document A 314 via the front side 102 interface. The first user may also choose to view and/or compose messages associated with document A 314 via the back side 104 interface (such as message A 334). Messages that are composed are linked to document A 314 and the first user (such as user A 330). Messages are also managed by the document manager 310. The first user may compose a message and address the message to another user. If another user receives the message linked to document A 314, the user may be automatically given access to view and edit document A 314. In this example, message A 334 is composed by the first user and addressed to the second user (such as user B 336).

The second user may receive message A 334 and automatically be given access to view and edit document A 314. In other words, the second user is linked to document A 314 in a similar manner as the first user. Similarly, the first user is linked to the second user. The second user may view and edit document A 314 via the front interface 102. If the second user edits any portion of document A 314, the edited document A 314 becomes the current version managed by the document manager 310. The second user may also choose to flip the front interface 102 over to view messages 320 associated with document A 314 via the back side interface 104. In one embodiment, the second user is only permitted to view messages linked with document A 314 that are addressed to the second user.

The second user may create and upload document B 316 to the document manager 310. In other words, the second user creates an HTML document by using the editing tool. In a further embodiment, the second user creates a link to a website or creates a document on a web application. Users may edit the document on a web application on the front side 102 and also flip to the back side 104 to communication with the system 200. The second user may view and edit document B 316 via the front interface 102 which displays document B 316. The second user may flip the front interface 102 over to compose and/or display messages associated with document B 316. The second user may compose and send a message (such as message B 340) linked with document B 316 to one or more other users (such as user C 342). The one or more users that receive the message may automatically be given access to view and edit document B 316. The third user may create and upload document C 318 in a similar manner as explained in relation to the first user and the second user. The third user may also compose, send and receive messages relating to document C as explained in connection with the first user and the second user.

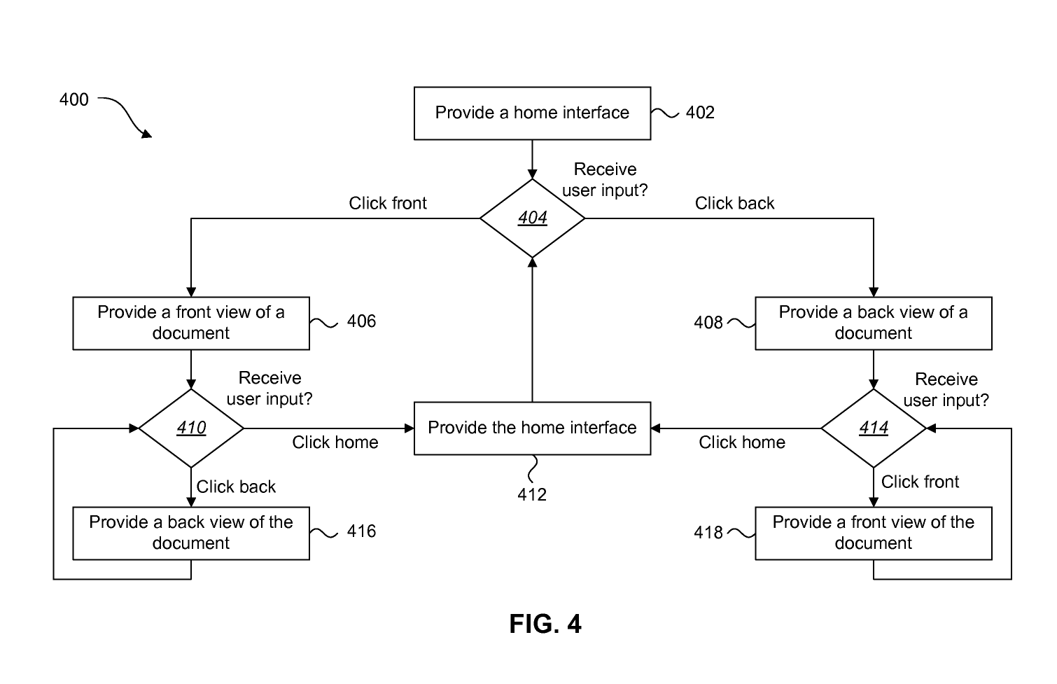

FIG. 4 is a flow diagram illustrating one embodiment of a method 400 of providing a front side interface 102 or a back side interface 104 associated with a document to a user. The method 400 may be implemented by the document manager 310. In one embodiment, a home interface is provided 402 to a user. The home interface may include a list of documents the user may access. A determination 404 is made as to whether or not user input is received at the home interface. The user input may include the user selecting one of the documents from the list of documents to view. In one embodiment, the user selects to view either a front side interface 102 or a back side interface 104 associated with the document.

If the user selects the front side interface 102, a front view of a document is provided 406. In one embodiment, the front view is a display of the document. The user may read, edit, etc. the document via the front side interface 102. The front view of the document is the most current version of the document. In other words, edits to the documents are incorporated into the front view of the document so that the user is viewing the most up to date version of the document. If the user selects the back side interface 104, a back view of the document is provided 408. In one embodiment, the back view is a display of messages addressed to the user associated with the document. The messages may be sent from other users that have read, edited, etc. the document. The messages may include the edits, comments, suggestions, etc. from the other users.

While the front view of the document is being displayed, it is determined 410 whether user input is received. In one embodiment, the user input may be a selection by the user to view a different interface associated with the document. For example, if the user is currently viewing the front view of the document, it is determined 410 whether user input is received to switch to the back view of the document. The user may make the selection by clicking a certain area on the front side interface 102 with a computer mouse or keyboard. If it is determined 410 that user input is received to switch to the back view, the back view is provided 416. In one embodiment, the front side interface 102 flips over to provide 416 the back side interface 104 which includes the back view of the document.

Alternatively, the user may select to view the home interface. If it is determined 410 that the user has chosen to view the home interface, the home interface is provided 412. In one embodiment, the user selects to view the home interface by clicking with the computer mouse or keyboard a certain area within the front side interface 102.

In a similar manner, while the back view of the document is provided 408, a determination 414 may be made as to whether user input is received. The user input may include a request for the front view of the document to be provided 418. In other words, while the user is viewing the back side of the document from the back side interface 104, the user may provide input (mouse click, strike of key(s) on the keyboard, etc.) to switch to the front side interface 102 in order to view the front of the document. In addition, the user input may include a request to provide 412 the home interface.

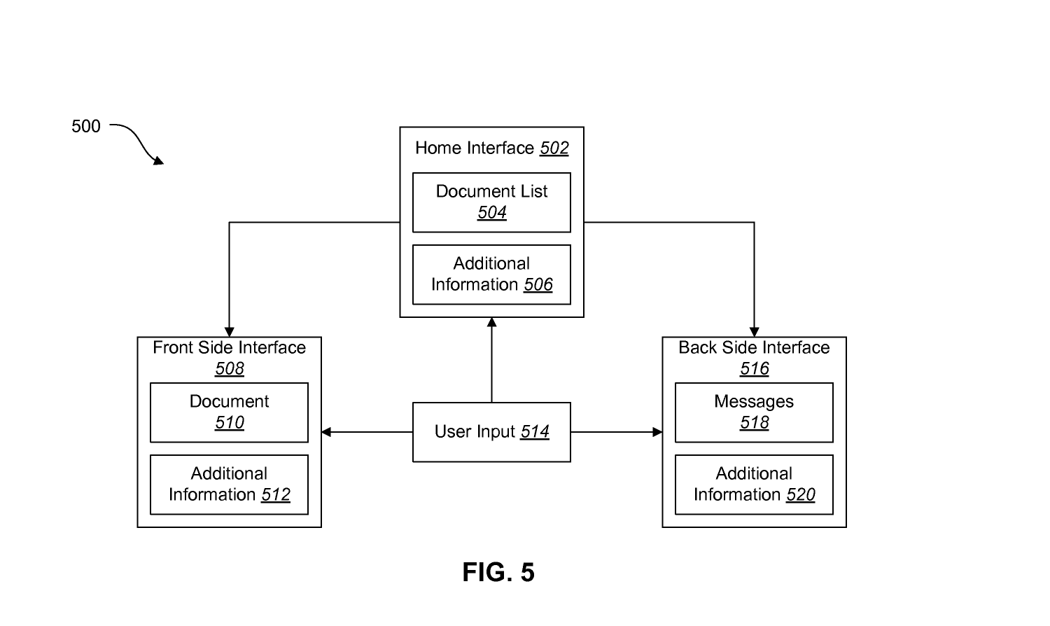

FIG. 5 is a block diagram illustrating one embodiment 500 of multiple interfaces that may be accessed by a user. A home interface 502 may include a document list 504 and additional home information 506. As previously explained, the document list 504 may include a list of documents the user may access to read, edit, send and receive messages, etc. A front side interface 508 may include a document 510 and additional front information 512. The document may be the document selected from the document list 504 from the home interface 502. A back side interface 516 may include messages 518 and additional back information 520. The messages may be messages relating to the document 510 displayed by the front side interface 508. User input 514 may allow a user to access each of these multiple interfaces. The user input may include a mouse click, keyboard command, etc.

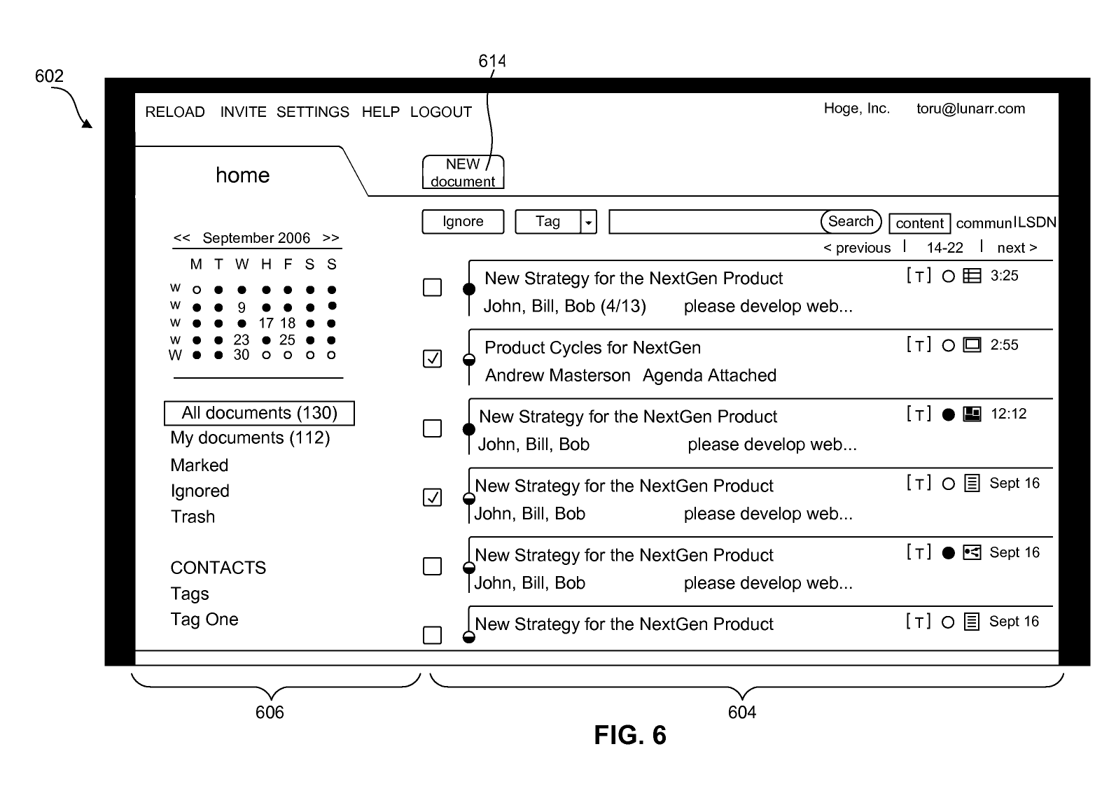

FIG. 6 is an embodiment of the home interface 602. As illustrated, the home interface 602 may include the document list 604 which lists one or more documents a user may access. Each of the documents in the document list 604 is the most current version of the document. The document list 604 may also include a summary of messages that have been received regarding a particular document on the list 604. As previously explained, the messages may be selected from the home interface 602 and viewed via the back side interface 104.

The home interface 602 also includes additional home information 606. In one embodiment, the additional home information 606 includes options for the user such as reload, invite, settings, help, logout, etc.

In a further embodiment, the additional home information 606 includes a list of contacts for the user. The information 606 may also indicate which documents from the document list 604 have been previously viewed by the user, which documents are new since the user last viewed the document list 604, etc. The home interface 602 may also allow the user to search the document list 604 for a particular document. The user may also assign or create a tag (also referred to as a label) associated with a document from the list 604. The tag (or label) may further define the properties of a document. The additional home information 606 may also include a calendar that provides an indication of an event. The event may be a deadline for certain edits for a document to be completed. An event may be indicated by the date appearing as a number on the calendar. If no such event exists on a certain day, a dot may be used to indicate the absence of an event.

The home interface 602 also includes an area 614 for user input. In one embodiment, the user input may include a tab 614 that the user may click with the computer mouse in order to execute a certain command. The command may be to create a new document. In addition, the user may click the name of a document within the document list 604 in order to view, edit, etc. the selected document.

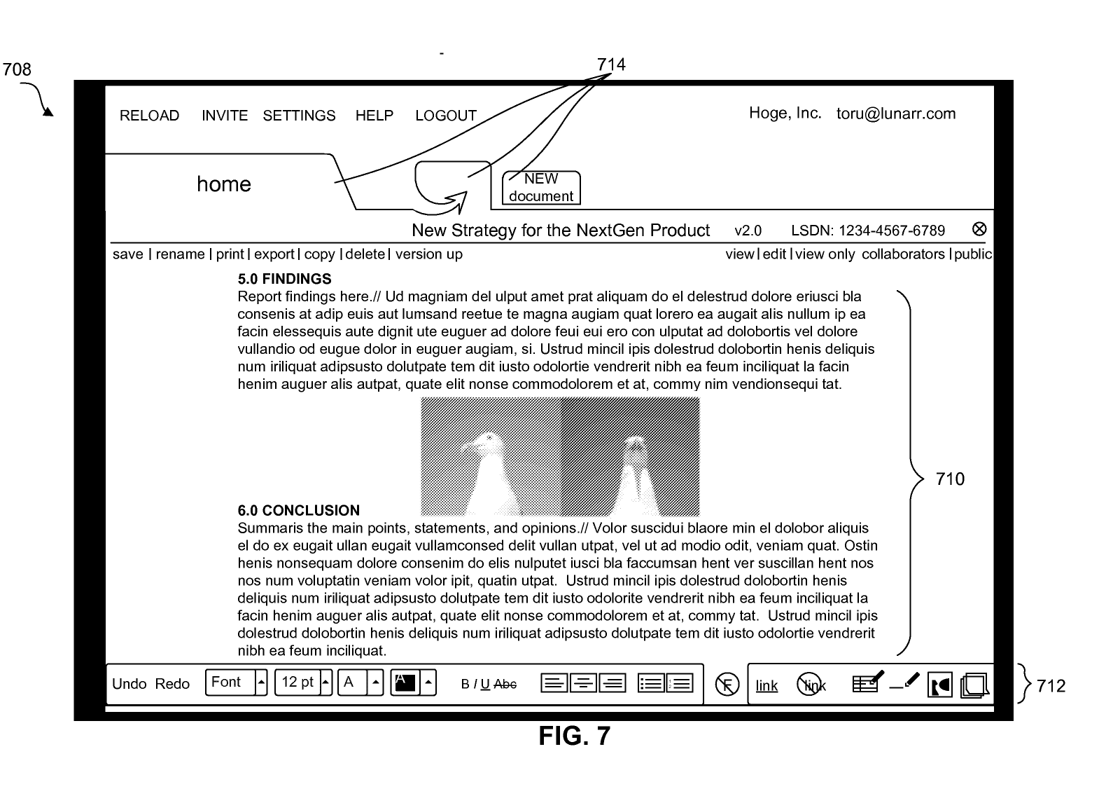

FIG. 7 is one embodiment of the front side interface 708. The interface 708 includes the document 710. The document 710 may be read, edited, etc. by a user. Additional front information 712 may include editing functions that assist the user to edit the document 710. For example, in an embodiment where the document 710 is a word-processing type of document, the additional front information 712 may include commands to edit the font style, size, etc. of the text of the document 710. In addition, the user may underline, strikethrough, italicize, etc. the text. The additional front information 712 may vary depending on what kind of document 710 is being displayed. The additional front information 712 also includes commands to save, rename, print, export, copy, delete, etc. the document 710. In addition, the front side interface 708 includes a user input 714. The user input 714 may be one or more tabs. A user may click on one tab to switch to the back side interface. Another tab may allow a user to access the home interface 602. Further, another tab may allow a user to create a new document.

FIG. 8 is one embodiment of the back side interface 816. The interface includes one or more messages 818 associated with the document 710 displayed on the front side interface 708. The messages 818 may be received and viewed by the user to whom the messages are directed. A user may also create and send one or more messages to other users via the back side interface 816 and may attach document(s) when sensing the message (document may be the document created on the system 200, uploaded file, URL, etc.) The interface 816 includes additional back information 820. The information 820 may indicate the number of new messages that have been received since the user last viewed the messages 818. The additional back information 820 may also include a list of the collaborators for the document 710. In other words, the list of collaborators provides an identification of the additional users that have access to view, edit, etc. the document 710. The information 820 may also provide the identity of the document 710 associated with the messages 818. The additional back information 820 may also include a log of all the revisions executed on the document 710 and the user which incorporated such revisions and version information. The additional back information 820 may also include information and links of other documents that are related to the document 710.

The back side interface 816 also includes a user input 814. The user input 814 may be one or more tabs. A user may click on one tab to switch to the front side interface. Another tab may allow a user to access the home interface 602. Further, another tab may allow a user to create a new document.

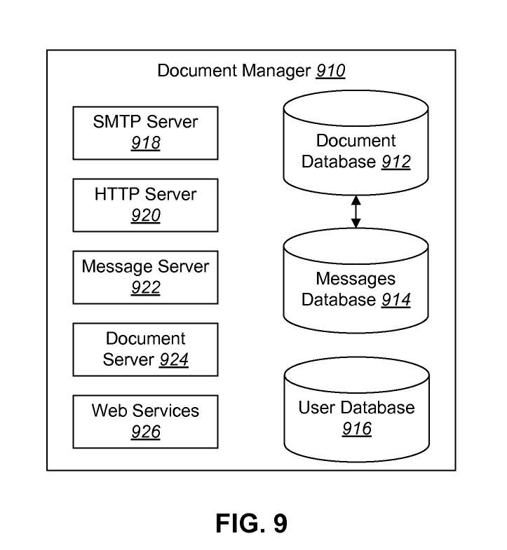

FIG. 9 is a block diagram illustrating one embodiment of the document manager 910. The manager 910 may include a document database 912 which may store documents that may be read and edited by a user. The document database 912 may be linked to a messages database 914 that stores messages associated with documents within the document database 912. In one embodiment, the documents may be viewed and edited by users that are part of a collaboration team. The messages within the messages database 914 may be viewed by the user to whom the messages are addressed. The manager 910 further includes a user database 916 that includes the identification of each user that is allowed to communicate with the document manager 910 in order to retrieve a document or messages associated with the document.

The document manager 910 also includes a plurality of servers that may be implemented to access the documents and messages. For example, the manager 910 may include a Simple Mail Transfer Protocol (SMTP) server 918. The SMTP server 918 may be used to transfer messages over the World Wide Web. The manager 910 may also include a Hypertext Transfer Protocol (HTTP) server 920. The HTTP server 920 may be used to transfer the documents and messages over the World Wide Web. The HTTP server 920 may publish and retrieve documents and messages in the Hypertext Markup Language (HTML).

In a further embodiment, the manager 910 includes a message server 922 that retrieves the messages from the messages database 914. Similarly, a document server 924 retrieves the documents from the document server 912. Web services 926 may be included in the document manager 910 to provide additional functions for the user in viewing and editing the document.

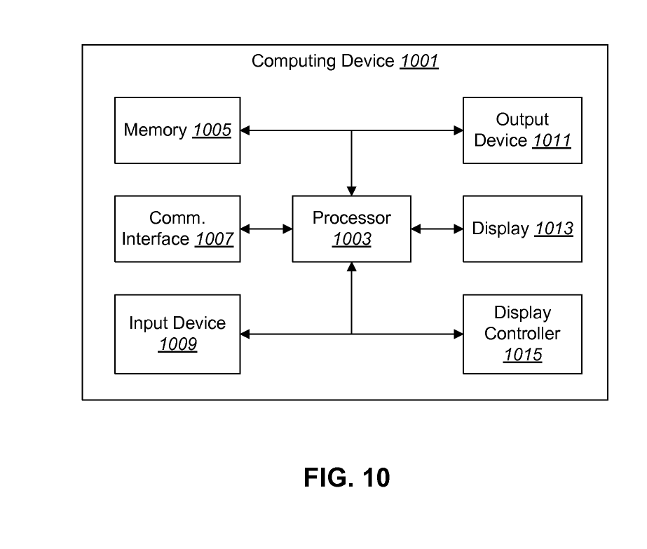

FIG. 10 illustrates various components that may be utilized in a computing device 1001. Embodiments of a client 202 and a document manager 210 are implemented through one or more computing devices 1001. The illustrated components may be located within the same physical structure or in separate housings or structures.

The device 1001 includes a processor 1003 and memory 1005. The processor 1003 controls the operation of the computing device 1001 and may be embodied as a microprocessor, a microcontroller, a digital signal processor (DSP) or other device. The processor 1003 typically performs logical and arithmetic operations based on program instructions stored within the memory 1005.

The device 1001 typically also includes one or more communication interfaces 1007 for communicating with other electronic devices. The communication interfaces 1007 may be based on wired communication technology, wireless communication technology, or both. Examples of different types of communication interfaces 1007 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, and so forth.

The computing device 1001 typically also includes one or more input devices 1009 and one or more output devices 1011. Examples of different kinds of input devices 1009 include a keyboard, mouse, microphone, remote control device, button, joystick, trackball, touchpad, lightpen, etc. Examples of different kinds of output devices 1011 include a speaker, printer, etc. One specific type of output device which is typically included in a computer system is a display device 1013. Display devices 1013 used with embodiments disclosed herein may utilize any suitable image projection technology, such as a cathode ray tube (CRT), liquid crystal display (LCD), light-emitting diode (LED), gas plasma, electroluminescence, or the like. A display controller 1015 may also be provided, for converting data stored in the memory 1005 into text, graphics, and/or moving images (as appropriate) shown on the display device 1013.

Of course, FIG. 10 illustrates only one possible configuration of a computing device 1001. Various other architectures and components may be utilized.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention.

What is claimed is:

1. A document server system comprising:
a computing device, the computing device comprising:
a plurality of electronic documents;
a plurality of messages relating to the electronic documents; and
an interface server for providing a client user interface to be displayed on a client display, wherein the client user interface provides:
a front user interface configured to display one of the plurality of electronic documents, wherein the front user interface includes a front switching input, wherein activation of the front switching input causes the client user interface to switch from the front user interface to a back user interface; and
the back user interface configured to display one or more of the plurality of messages, wherein the back user interface includes a back switching input, wherein activation of the back switching input causes the client user interface to switch from the back user interface to the front user interface.

2. The system of claim 1, wherein the front user interface comprises a public area that is accessible by one or more authorized users.

3. The system of claim 1, wherein the back user interface comprises a private area that is accessible by an authorized user.

4. The system of claim 1, wherein the computing device is configured to automatically grant a user access to an electronic document upon receipt of a message relating to the electronic document.

5. The system of claim 1, wherein the computing device is configured to attach an electronic document different from one of the plurality of electronic documents to a message.

6. The system of claim 5, wherein the computing device is configured to link the electronic document to one of the plurality of electronic documents.

7. The system of claim 1, wherein the front switching input and the back switching input are configured to execute a plurality of functions.

8. The system of claim 1, wherein each of the plurality of electronic documents comprise an identifier that links each of the plurality of electronic documents to a corresponding physical document.

9. The system of claim 1, wherein the front user interface further comprises a toolbar for editing each of the plurality of electronic documents.

10. A method for providing multiple user interfaces relating to an electronic document, the method comprising:
providing a plurality of electronic documents;
providing a plurality of messages relating to the electronic documents; and
providing a client user interface to be displayed on a client display, wherein the client user interface provides:
a front user interface configured to display one of the plurality of electronic documents, wherein the front user interface includes a front switching input, wherein activation of the front switching input causes the client user interface to switch from the front user interface to a back user interface; and
the back user interface configured to display one or more of the plurality of messages, wherein the back user interface includes a back switching input, wherein activation of the back switching input causes the client user interface to switch from the back user interface to the front user interface.

11. The method of claim 10, wherein the front user interface comprises a public area that is accessible by one or more authorized users.

12. The method of claim 10, wherein the back user interface comprises a private area that is accessible by an authorized user.

13. The method of claim 10, further comprising automatically granting a user access to an electronic document upon receipt of a message relating to the electronic document.

14. The method of claim 10, further comprising attaching an electronic document that is different from one of the plurality of electronic documents to a message.

15. The method of claim 14, further comprising linking the attached electronic document to one of the plurality of electronic documents.

16. The method of claim 10, wherein the front switching input and the back switching input are configured to execute a plurality of functions.

17. The method of claim 10, wherein each of the plurality of electronic documents comprise an identifier.

18. The method of claim 17, further comprising linking each of the plurality of electronic documents to a corresponding physical document with the identifier.

19. The method of claim 10, further comprising providing an editing toolbar for editing electronic documents within the front user interface.

20. A computer-readable medium comprising executable instructions to:
provide a plurality of electronic documents;
provide a plurality of messages relating to the electronic documents; and
provide a client user interface to be displayed on a client display, wherein the client user interface provides:
a front user interface configured to display one of the plurality of electronic documents, wherein the front user interface includes a front switching input, wherein activation of the front switching input causes the client user interface to switch from the front user interface to a back user interface; and
the back user interface configured to display one or more of the plurality of messages, wherein the back user interface includes a back switching input, wherein activation of the back switching input causes the client user interface to switch from the back user interface to the front user interface.

21. The computer readable medium of claim 20, wherein the instructions are further executable to link a document to a first user and link the first user to one or more additional users through an exchange of the messages or collaboration of the plurality of documents.

22. The computer readable medium of claim 20, wherein the instructions are further executable to provide a calendar, wherein a dot on a particular date of the calendar indicates the absence of an event on the particular date.
